(19) United States
(12) Patent Application Publication
(10) Pub. No.: US 2023/0177620 A1
(43) Pub. Date: Jun. 8, 2023

(54) APPARATUS AND METHOD FOR DETERMINING AND TRACKING HANDWRITTEN TIP AMOUNTS

(71) Applicants: Spencer Davis, Denver, CO (US); Shelby McCoy, Denver, CO (US)

(72) Inventors: Spencer Davis, Denver, CO (US); Shelby McCoy, Denver, CO (US)

(21) Appl. No.: 17/541,763

(22) Filed: Dec. 3, 2021

(51) Int. Cl. G06Q 40/00; G06V 30/142; G06V 30/26; G06V 30/22; G06V 30/32

(52) U.S. Cl. CPC G06Q 40/125; G06V 30/142; G06V 30/26; G06V 30/22; G06V 30/32

(57) ABSTRACT

A system and method for determining a value of a hand written monetary tip amount on a paper payment receipt is provided. One embodiment scans, using a scanner, a paper payment receipt having a hand written monetary tip amount thereon; generates scan data that corresponds to the scanned paper payment receipt: identifies text from the scan data, wherein the identified text includes hand written text and machine printed text; discriminates the hand written text from the machine printed text; and determines a value of the hand written monetary tip amount based on the identified hand written text.

### BACKGROUND OF THE INVENTION

Service establishments provide a service to their customers. For example, a bar or restaurant may serve beverages and/or food to their customers. Often, a service person is involved with providing the service to the customer.

Customers may pay for their service using a form of electronic payment, such as a credit card, debit card or the like. Often, the customer is presented a paper payment receipt for review and signature approval. Typically, a predefined space on the paper payment receipt is reserved for the customer to provide a gratuity (interchangeable referred to herein as a “tip”) in appreciation to the service provided by the service provider. The customer fills in an intended monetary tip amount using their hand writing on the paper payment receipt.

At some juncture, typically in the evening after the closing of the business, an employee must manually review the paper payment receipt to determine the tip amount. Often, there are many paper payment receipts, even hundreds of paper payment receipts, which must manually be processed each day. Manually processing each paper payment receipt to determine the tip amount is time consuming and labor intensive. Further, tip amounts must be manually entered into an accounting system or the like for business and tax purposes.

Accordingly, in the arts of providing consumer services, and in particular for determining monetary tip amounts that have been hand written on paper payment receipts, there is a need in the arts for improved methods, apparatus, and systems for determining and tracking these monetary tip amounts.

### SUMMARY OF THE INVENTION

Embodiments of a tip determination and tracking system determine a value of a hand written monetary tip amount from identified hand written text on a paper payment receipt. One embodiment scans, using a scanner, a paper payment receipt having a hand written monetary tip amount thereon; generates scan data that corresponds to the scanned paper payment receipt; identifies text from the scan data, wherein the identified text includes hand written text and machine printed text; discriminates the hand written text from the machine printed text; and determines a value of the hand written monetary tip amount based on the identified hand written text.

### BRIEF DESCRIPTION OF THE DRAWINGS

The components in the drawings are not necessarily to scale relative to each other. Like reference numerals designate corresponding parts throughout the several views.

FIG. 1 is a block diagram of a tip determination and tracking system.

FIG. 2 is an example block diagram of an example computing system that may be used to practice embodiments of a tip determination and tracking system described herein.

FIG. 3 is a block diagram of the tip determination and tracking system employing an image capture type scanner.

### DETAILED DESCRIPTION

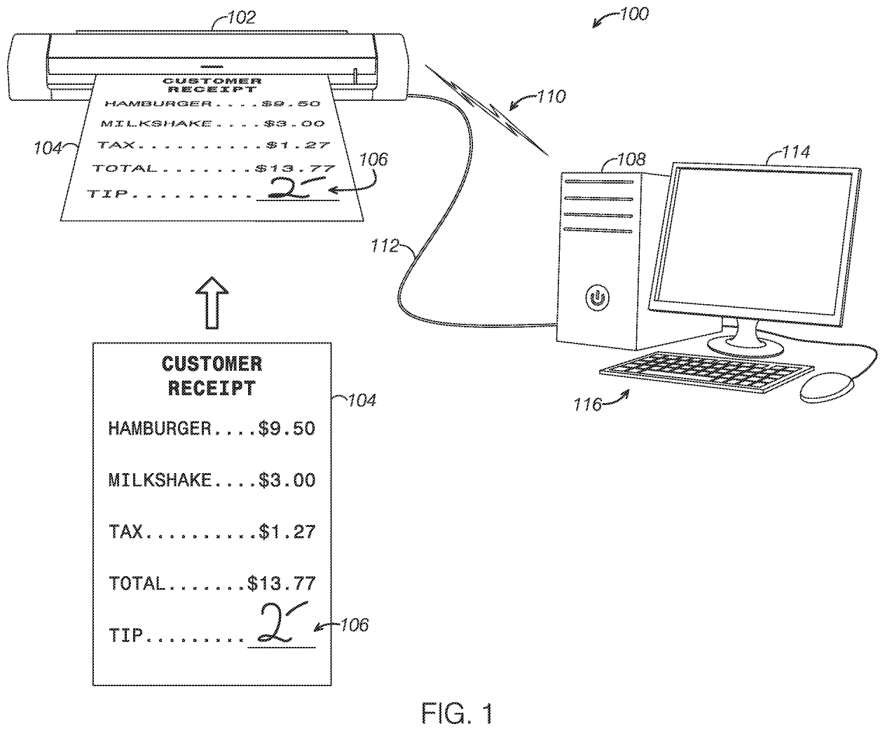

FIG. 1 is a block diagram of a tip determination and tracking system 100. Embodiments of the electronic tip determination and tracking system 100 comprise one or more scanning devices 102 that are used by an employee to scan a paper payment receipt 104 with a hand written monetary tip amount 106 thereon. The scanned data is then processed to identify the value (amount) of the hand written monetary tip 106.

The disclosed systems and methods for scanning paper payment receipts 104 to determine hand written tip amounts using embodiments of the tip determination and tracking system 100 will become better understood through review of the following detailed description in conjunction with the figures. The detailed description and figures provide examples of the various inventions described herein. Those skilled in the art will understand that the disclosed examples may be varied, modified, and altered without departing from the scope of the inventions described herein. Many variations are contemplated for different applications and design considerations, however, for the sake of brevity, each and every contemplated variation is not individually described in the following detailed description.

Throughout the following detailed description, a variety of examples for systems and methods for a tip determination and tracking system 100 are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components. “Secured to” means directly connected without intervening components.

“Communicatively coupled” means that an electronic device exchanges information with another electronic device, either wirelessly or with a wire based connector, whether directly or indirectly through a communication network 108. “Controllably coupled” means that an electronic device controls operation of another electronic device.

Returning to FIG. 1, embodiments of the tip determination and tracking system 100 employ any suitable scanner 102 that is configured to scan a paper payment receipt 104 with a hand written tip amount 106. Preferably, though not necessary, the scanner 102 is a hand held scanning device. The scan data may be in any suitable electronic format, such as a digitized image, an image, or digitized scanned line data. For example, but not limited to, the scanner may be configured to capture digital images using a charge coupled device (CCD) or an active-pixel sensor (CMOS sensor). Any suitable scanner 102 now known or later developed is intended to be included within the scope of this disclosure and to be protected by the accompanying claims.

In the example embodiment illustrated in FIG. 1, the scan data is communicated to a computer 108 via a wireless signal 110 and/or a wire-based connector 112. The computer 108 analyzes the received scan data from the scanner 102 and determines a value of the hand written tip amount 106 using text recognition and handwriting analysis algorithms.

Preferably, the handwriting recognition is managed by an artificial intelligence (Al) engine (algorithm or system) so that the value of the tip 106 can be accurately determined with a high degree of reliability. In example embodiments, the Al algorithm is configured to determine a prediction value of the hand written monetary tip amount 106 as well as determine the probability of correctly determining the value of the hand written monetary tip amount 106. If the probability is less than a predefined probability value threshold, that particular paper payment receipt 104 may be identified. The employee scanning that paper payment receipt 104 may be alerted or notified so that the employee can personally determine the value of the hand written monetary tip amount 106. Optionally, the employee may then enter their determined value into the tip determination and tracking system 100 so that that particular paper payment receipt 104 is processed by the tip determination and tracking system 100.

Optionally, the tip determination and tracking system 100 further processes the determined tip amounts 106 from a plurality of paper payment receipts 104. A suitable accounting program can be used to track the determined tip amounts 106 collected during some predefined period, such as one work day or other period of interest.

Some customer paper payment receipts may include supplemental information that identifies the particular server. For example, the server's name or nickname may be indicated on the paper payment receipt 104. Alternatively or additionally, a table or other service location associated with a particular server may be indicated on the paper payment receipt 104. Embodiments of the tip determination and tracking system 100 may be configured to associate determined tip amounts 106 with a particular server. This feature is advantageous when the server's compensation is, in part, based on the amount of their collected tips 106.

Other supplemental information of interest may be associated with the determined tip amounts 106. Such information may include the customer's name, card information, and/or order information. In some instances, a customer may provide hand written comments. Embodiments of the tip determination and tracking system 100 may be optionally configured to determine any supplemental information of interest, associate the supplemental information with the paper payment receipt 104, and then save the associated supplemental information for later use.

Embodiments of the tip determination and tracking system 100 are configured to generate summary reports or the like indicating tip value (amount) totals received during the predefined period and/or by an identified server. These reports may be presented on the display 114 of the computer 108. A suitable input/output device 116, such as the example keyboard, may be used to input supplemental information of interest and/or control generation of output reports. Any suitable computer system, such as a lap top, personal device assistant, notebook, tablet or the like may be used to receive and process scan data acquired by the scanner 102. In some embodiments, the computer may be an integrated component of the scanner 102. All such variations are intended to be included within the scope of this disclosure and to be protected by the accompanying claims.

Further, some embodiments may be configured to integrate the determined tip amounts 106 with electronic determined tip amounts obtained by other electronic devices. For example, the customer may have paid by credit card or cash at the front desk of the business establishment. If the tip was paid by the customer without a paper payment receipt 104 with a hand written tip amount 106, the tip amount may be communicated to the tip determination and tracking system 100. These non-hand written tip amounts may then be integrated with the determined tip amounts 106 from the scanned paper payment receipts 104.

One skilled in the art appreciates that embodiments of the tip determination and tracking system 100 may quickly determine and process tip amounts 106 in a fast and efficient manner. The only real limitation is the speed at which an employee may feed the paper payment receipt 104 through the scanner 102 or capture images of a plurality of the paper payment receipts 104. The legacy process of manually reviewing each individual paper payment receipt 104 to determine the value of each hand written tip amount 106, which previously required as much as an hour or more, can be accomplished in a matter of minutes using embodiments of the tip determination and tracking system 100.

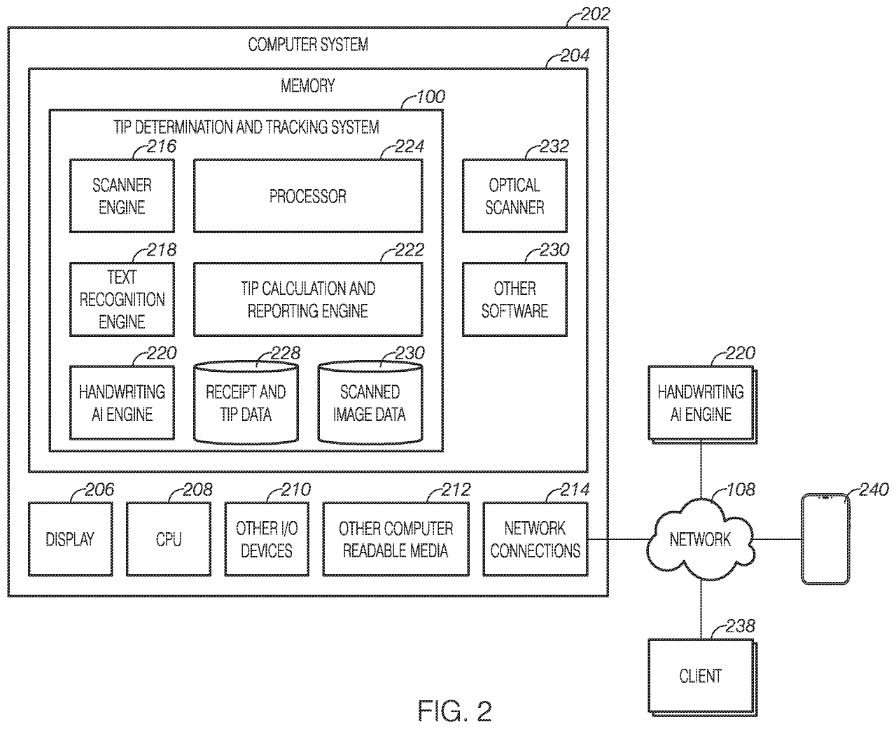

FIG. 2 is an example block diagram of an example computing system 202 that may be used to practice embodiments of a tip determination and tracking system 100 described herein. Note that one or more general purpose virtual or physical computing systems suitably instructed or a special purpose computing system may be used to implement a tip determination and tracking system 100. Further, the tip determination and tracking system 100 may be implemented in software, hardware, firmware, or in some combination to achieve the capabilities described herein.

Note that one or more general purpose or special purpose computing systems/devices may be used to implement the described techniques. However, just because it is possible to implement the tip determination and tracking system 100 on a general purpose computing system does not mean that the techniques themselves or the operations required to implement the techniques are conventional or well known.

The computing system 202 may comprise one or more server and/or client computing systems, and/or may span distributed locations. In addition, each block shown may represent one or more such blocks as appropriate to a specific embodiment or may be combined with other blocks. Moreover, the various blocks of the computer system 202 may physically reside on one or more machines, which use standard (e.g., TCP/IP) or proprietary interprocess communication mechanisms to communicate with each other.

In the embodiment shown, computer system 202 comprises a computer memory (“memory”) 204, a display 206, one or more Central Processing Units (“CPU”) 208, Input/Output (I/O) devices 210 (e.g., keyboard, mouse, CRT or LCD display, etc.), other computer-readable media 212, and one or more network connections 214. The tip determination and tracking system 100 is shown residing in memory 204. In other embodiments, some portion of the contents, some of, or all of the components of the tip determination and tracking system 100 may be stored on and/or transmitted over the other computer-readable media 212. The components of the tip determination and tracking system 100 preferably execute on one or more CPUs 208 and manage the generation and use of the scanner engine 216, the text recognition engine 218, the handwriting artificial intelligence (Al) engine 220, and the tip calculation and reporting engine 222 and processor 224, as described herein. The memory 204 also contains regions for storing data, such as, but not limited to the scanned image data 226, and the receipt and tip data 228. Other code or programs 230 and potentially other data repositories may also reside in the memory 204, and preferably execute on one or more CPUs 208. Of note, one or more of the components in FIG. 1 may not be present in any specific implementation. For example, some embodiments embedded in other software may not provide means for user input or display.

In a typical embodiment, the computer system 202 optionally includes one or more optical scanners 232. In at least some embodiments, the optical scanner 102 may be provided external to the tip determination and tracking system 100, and is available, potentially, over one or more networks 236.

Other and/or different modules may be implemented. In addition, the tip determination and tracking system 100 may interact via a network 236 with a client 238 that provides supplemental information (such as a credit card site), and/or one or more portable electronic devices (such as the smart phone 240 which may be used to scan a paper payment receipt 104 with a hand written tip amount 106).

Also, of note, the data repositories 226, 228 may be provided external to the computer system 202 as well, for example in a WWW knowledge base accessible over one or more networks 236. Similarly, the handwriting artificial intelligence (Al) engine 220 may be remote from the computer 202 such that scanned the scan data having the hand written tip amounts 106 are communicated to the remote handwriting artificial intelligence (AI) engine 220 wherein a value of the hand written tip amount 106 are determined.

In an example embodiment, components/modules of the tip determination and tracking system 100 are implemented using standard programming techniques. For example, the tip determination and tracking system 100 may be implemented as a “native” executable running on the CPU 208, along with one or more static or dynamic libraries. In other embodiments, the tip determination and tracking system 100 may be implemented as instructions processed by a virtual machine. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use well-known or proprietary, synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously and communicate using message passing techniques. Equivalent synchronous embodiments are also supported.

In addition, programming interfaces to the data stored as part of the tip determination and tracking system 100 (e.g., in the data repositories 226 and 228) can be available by standard mechanisms such as through C, C++, C#, and Java APIs; libraries for accessing files, databases, or other data repositories; through scripting languages such as XML; or through Web servers, FTP servers, or other types of servers providing access to stored data. The databases 226, 228 may be implemented as one or more database systems, file systems, or any other technique for storing such information, or any combination of the above, including implementations using distributed computing techniques.

Also the example tip determination and tracking system 100 may be implemented in a distributed environment comprising multiple, even heterogeneous, computer systems and networks. Different configurations and locations of programs and data are contemplated for use with techniques of described herein. In addition, the [server and/or client] may be physical or virtual computing systems and may reside on the same physical system. Also, one or more of the modules may themselves be distributed, pooled or otherwise grouped, such as for load balancing, reliability or security reasons. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) and the like. Other variations are possible. Also, other functionality could be provided by each component/module, or existing functionality could be distributed amongst the components/modules in different ways, yet still achieve the functions of the tip determination and tracking system 100.

Furthermore, in some embodiments, some or all of the components of the tip determination and tracking system 100 may be implemented or provided in other manners, such as at least partially in firmware and/or hardware, including, but not limited to one or more application-specific integrated circuits (ASICs), standard integrated circuits, controllers executing appropriate instructions, and including microcontrollers and/or embedded controllers, field-programmable gate arrays (FPGAs), complex programmable logic devices (CPLDs), and the like. Some or all of the system components and/or data structures may also be stored as contents (e.g., as executable or other machine-readable software instructions or structured data) on a computer-readable medium (e.g., a hard disk: memory: network; other computer-readable medium; or other portable media article to be read by an appropriate drive or via an appropriate connection, such as a DVD or flash memory device) to enable the computer-readable medium to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

In a non-limiting embodiment, the employee captures an image of the paper payment receipt 104 using their scanner 102. As defined herein, the scanner 102 may be an electronic device with a paper feed system that passes the paper payment receipt 104 over a scanning sensor. Alternatively, the scanner 102 may be an electronic device that captures an image of the paper payment receipt 104.

The paper payment receipt 104 includes both machine printed text, such as text printed by a printing machine, and hand written text written by a customer specifying a value of the hand written monetary tip 106. The scanner engine 218, executed by the processor 224, receives the scan data or the image data (interchangeably referred to herein as scan data) from the scanner 102 (optical scanner 232 or another electronic device, such as the smart phone 240). The scan data may be optionally stored into the scammed image data 230 of memory 204.

The processor 224, executing the text recognition engine 218, may preprocess the scan data by cropping out data that is not part of the paper payment receipt 104. Then, the processor 224 identifies text shown on the paper payment receipt 104 (which is discernable from the scan data generated by the scanner 102) using a suitable text identification algorithm now known or later developed. The identified discernable text includes, in part, the hand written monetary tip amount 106 and machine printed text. The handwriting Al engine 220, executing under the processor 224, identifies the hand written monetary tip amount 106, which differs from the machine printed text on the hand written monetary tip amount 106. That is, the handwritten text is identified since handwritten text is different from the printed text generated by the payment processing machine (not shown). Then, the handwriting Al engine 220 identifies numerical characters in the identified hand written text.

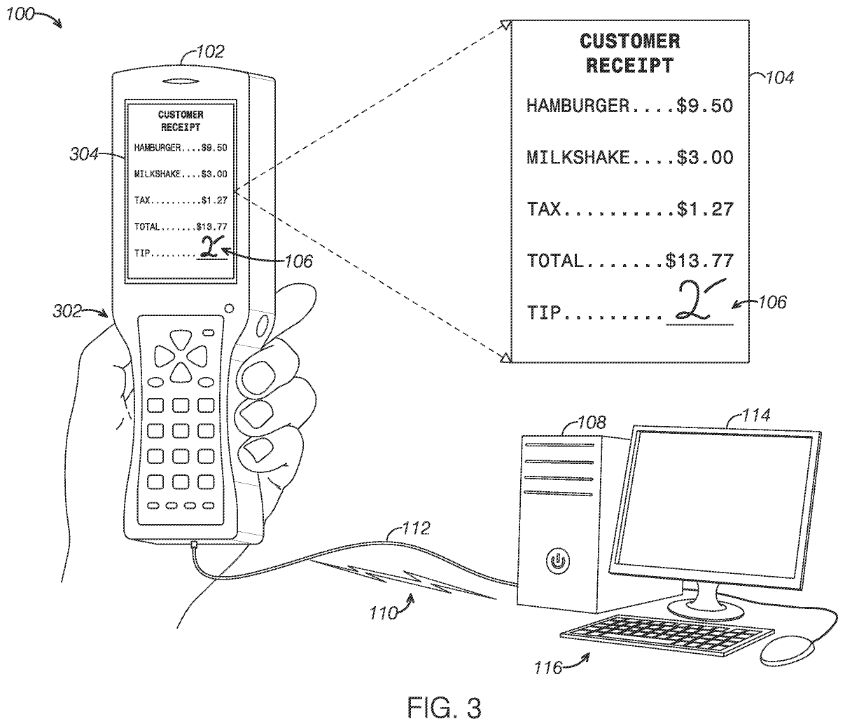

The identified hand written numbers are used to determine a value of the hand written monetary tip amount 106. In the conceptual example of FIGS. 1 and 3, the determined hand written monetary tip amount 106 is conceptually illustrated as two dollars ($2.00). The value of the tip amount, along with any identified supplemental information, is then stored into the receipt and tip data 228 of memory 204.

Other software 230 may then be used to further process the stored hand written monetary tip amounts 106 determined from a plurality of paper payment receipts 104. For example, an accounting program 230 may be used to determine a total tip amount for the employee based on the plurality of scanned paper payment receipts 104 each having a unique hand written monetary tip amount 106. The employee can then be compensated accordingly. Additionally. or alternatively, the determined hand written monetary tip amounts 106 may be used for other purposes, such as tax accounting or the like. Further, a plurality of different software 230 may be configured to process the stored hand written monetary tip amounts 106.

Alternatively, or additionally, the determined value of the stored hand written monetary tip amounts 106 and other supplemental information of interest may be communicated to other remote devices 238 for further processing. Supplemental information of interest may include the customer name, name of the business providing the service, service date, service location, etc. For example, the remote device 238 may be a server managed by a payment entity, such as credit card or debit card vendor, who paid the paper payment receipt 104 and the hand written monetary tip amount 106 on behalf of the customer.

Optionally, the Al determined value of the hand written monetary tip amount 106, along with probability information indicating the probable accuracy of the determined value, may be stored for later review and/or use by payment entity. In some applications, the customer may access the stored information for their review and approval.

One skilled in the art appreciates that identifying hand written text from machine printed text is a complicated process that requires a high degree of accuracy (correctness of the determined value) and reliability (high probability that the determination was accurate, referred to herein as an accuracy probability). Further, identifying a numerical amount from had written text is particularly difficult because every customer has different hand writing. Accordingly, embodiment of the tip determination and tracking system 100 employ one or more artificial intelligence algorithms that, over time, enable the image capture type scanner 102 to accurately and reliably determine the hand written monetary tip amount 106 on a plurality of different paper payment receipts 104 having hand written tip amounts from different customers.

In some situations, the employee may inadvertently make multiple scans of the same paper payment receipt 104. Embodiments of the tip determination and tracking system 100 may be configured to verify that a scanned paper payment receipt 104 has not be previously scanned. For example, a receipt identifier or the like may be determined from the machine printed text shown in the image data. The receipt identifier may then be associated with the determined hand written monetary tip amount 106 and/or an employee who served the customer that paid the paper payment receipt 104. Alternatively, or additionally, the determined hand written text may be compared with the had written text of previously processed paper payment receipts 104. If there is an identical match in compared handwritten text, then a determination is made that the paper payment receipt 104 has been scanned multiple times. Such duplicated scans of a paper payment receipt 104 can then be rejected by the tip determination and tracking system 100.

FIG. 3 is a block diagram of the tip determination and tracking system 100 employing an image capture type scanner 102. In practice, the employee actuates the controllers 302 to cause the image capture type scanner 102 to capture an image of the paper payment receipt 104 (which includes the hand written monetary tip amount 106). Alternatively, a touch sensitive display 304 may be used to operate the image capture type scanner 102.

The acquired image data is then communicated to the computer 108 for determination of the amount of the hand written monetary tip 106. The image capture type scanner 102 may be any suitable electronic device configured to capture at least images of objects, such as the paper payment receipt 104. Preferably, the image capture type scanner 102 is a hand held device. The image capture type scanner 102 may be a special purpose device or a multi-purpose device, such as a smart phone. A smart phone app (application) residing in the smart phone may be executed by the employee to acquire an image of the paper payment receipt 104, establish a link to the computer 108, and then communicate the image data to the computer 108.

It should be emphasized that the above-described embodiments of the tip determination and tracking system 100 are merely possible examples of implementations of the invention. Many variations and modifications may be made to the above-described embodiments. All such modifications and variations are intended to be included herein within the scope of this disclosure and protected by the following claims.

Furthermore, the disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower, or equal in scope to the original claims, are to be considered within the subject matter of the inventions described herein.

Therefore, having thus described the invention, at least the following is claimed:

1. A method, comprising:
scanning, using a scanner, a paper payment receipt having a hand written monetary tip amount thereon:
generating scan data that corresponds to the scanned paper payment receipt;
identifying text from the scan data, wherein the identified text includes hand written text and machine printed text:
discriminating the hand written text from the machine printed text; and
determining a value of the hand written monetary tip amount based on the identified hand written text.

2. The method of claim 1, wherein the electronic device determines the value of the hand written monetary tip amount using an artificial intelligence algorithm, the method further comprising:
determining an accuracy probability of the determined value of the hand written monetary tip amount.

3. The method of claim 1, wherein the scanning, generating the scan data, identifying the text, discriminating the hand written text from the machine printed text, and determining the value of the hand written monetary tip amount are performed by an electronic device.

4. The method of claim 3, wherein the electronic device is a smart phone.

5. The method of claim 3, wherein the electronic device acquires a digital image of the paper payment receipt.

6. The method of claim 1, wherein the scanning is performed by a first electronic device, and wherein generating the scan data, identifying the text, discriminating the hand written text from the machine printed text, and determining the value of the hand written monetary tip amount are performed by a second electronic device.

7. The method of claim 6, wherein the first electronic device is a smart phone.

8. The method of claim 6, wherein the first electronic device acquires a digital image of the paper payment receipt.

9. The method of claim 1, further comprising:
performing, for a plurality of different paper payment receipts each having different hand written monetary tip amounts thereon, the scanning, generating the scan data, identifying the text, discriminating the hand written text from the machine printed text, and determining the value of the hand written monetary tip amount;
storing each of the determined values; and
generating a report indicating the stored values.

10. The method of claim 1, further comprising:
identifying a name of an employee who served a customer that wrote the hand written monetary tip amount on the paper payment receipt, wherein the name of the employee is identified based on the identified machine printed text; and
associating the name of the employee with the value of the hand written monetary tip amount.

11. The method of claim 10, further comprising:
performing, for a plurality of different paper payment receipts each having different hand written monetary tip amounts thereon, the scanning, generating the scan data, identifying the text, discriminating the hand written text from the machine printed text, determining the value of the hand written monetary tip amount, identifying the name of the employee, and associating the employee name with the value:
storing each of the determined values; and
generating a report indicating the stored values for the employee identified by the employee name.

12. The method of claim 1, further comprising:
identifying a receipt identifier associated with the paper payment receipt, wherein the receipt identifier is identified based on the identified machine printed text; and
associating the receipt identifier with the value of the hand written monetary tip amount.

13. The method of claim 1, further comprising:
communicating the determined value of the stored hand written monetary tip amount and supplemental information to a remote device.

14. The method of claim 13, wherein the supplemental information includes a customer name, a name of a business providing a service charged for the paper payment receipt, a service date, and a service location.

15. The method of claim 13, wherein determining the value of the hand written monetary tip amount is performed by an artificial intelligence algorithm, and wherein the supplemental information includes accuracy probability information indicating the probable accuracy of the determined value.

16. A tip determination and tracking system, comprising:
a scanner that acquires at least one image of a paper payment receipt having a hand written monetary tip amount thereon;
a computer system communicatively coupled to the scanner and configured to receive image data corresponding to image of the paper payment receipt acquired by the scanner; and
a memory communicatively coupled to the computer system,
wherein the computer system, executing a handwriting artificial intelligence (Al) engine stored in the memory, identifies hand written text and machine printed text which is discernable in the received image data, and determines a value of the hand written monetary tip amount based on the identified hand written text.

17. The tip determination and tracking system of claim 16, wherein the scanner, the computer system and the memory are integrated into an electronic device.

18. The tip determination and tracking system of claim 17, wherein the electronic device is a smart phone that captures an image of the paper payment receipt, and wherein the captured image includes the hand written text.

19. The tip determination and tracking system of claim 16, wherein the scanner is remote from the computer system and the memory.

20. The tip determination and tracking system of claim 19, wherein the scanner is a smart phone that captures an image of the paper payment receipt, and wherein the captured image includes the hand written text.
